(19) United States
(12) Patent Application Publication
(10) Pub. No.: US 2022/0324532 A1
(43) Pub. Date: Oct. 13, 2022

(54) METHOD OF ATTACHING HUBS TO BICYCLE FRAME

(71) Applicant: REX ENTERPRISES, dba RAMBO BIKES, Lakeville, MN (US)

(72) Inventor: Robert MEYER, Lakeville, MN (US)

(73) Assignee: REX ENTERPRISES, dba RAMBO BIKES, Lakeville, MN (US)

(21) Appl. No.: 17/224,341

(22) Filed: Apr. 7, 2021

(51) Int. Cl. B62K 25/02; B62M 9/125; B62K 19/38

(52) U.S. Cl. CPC B62K 25/02; B62M 9/125; B62K 19/38

(57) ABSTRACT

Chips removably attached to a bicycle frame allow different size hubs and axles to be connected to a frame. As the frame represents a major part of the investment in a bicycle, the chips allow a single frame to accommodate different wheels. The user can then use a wheel having the appropriate tire and attachments for the terrain to be traversed. For instance, a particular wheel and tire would be used for a downhill mountain trail, another wheel used for riding on paved surfaces and a third wheel hub would be used for loose surfaces, such as sand or gravel. Therefore, the user is able to adapt the bicycle for a variety of different terrains and uses.

### FIELD OF THE INVENTION

The invention related to a method for allowing different wheels to be attached to a bicycle frame in a simple, efficient and interchangeable manner.

### BACKGROUND OF THE INVENTION

The typical bicycle wheel has a rubber tire 12 supported on a rim 14, as seen in FIG. 1. The rim 14 attaches to a hub 18 through a plurality of spokes 18. An axle extends through the hub and the entire wheel rotates about the axle. The axle has a length so as to extend from both ends of the hub. For the purposes of the description of the invention, the term hub will include the hub and axle.

The typical bicycle frame has a top tube 20 and a bottom tube 22 extending between a head tube 24 and a seat tube 26. The head tube receives a front fork and handle bars for steering. A bottom bracket 32 at the bottom of the seat tube 26 supports the pedal crank. A pair of seat stays 28 extends rearwardly from a top of the seat tube and a pair of chain stays 30 extends rearwardly from the bottom of the seat tube. A first pair of a seat stay and a chain stay join together at a distal end to form a first rear end of the frame and a second pair of a seat stay and a chain stay join together at a distal end to form a second rear end of the frame. The distance between the first rear end of the frame and the second rear end of the frame is fixed and a length of the axle of the wheel to be attached is greater than this distance. Therefore, dropouts 34 allowing the attachment of the wheel to the frame are slots into which the axle of the wheel is inserted.

### SUMMARY OF THE INVENTION

Chips removably attached to a bicycle frame allow different size hubs and axles to be connected to a frame. As the frame represents a major part of the investment in a bicycle, the chips allow a single frame to accommodate different wheels. The user can then use a wheel having the appropriate tire and attachments for the terrain to be traversed. For instance, a particular wheel and tire would be used for a downhill mountain trail, another wheel used for riding on paved surfaces and a third wheel hub would be used for loose surfaces, such as sand or gravel. Therefore, the user is able to adapt the bicycle for a variety of different terrains and uses.

It is an object of the invention to provide a method for attaching different wheels to a bicycle frame.

It is another object of the invention to provide an inexpensive method for adapting a bicycle to different terrains.

It is yet another object to provide a method for securing attaching wheels of different sizes to a bicycle frame.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 is a side view of a cycle wheel rim having a wheel hub;

FIG. 2 is a side view of a bicycle frame;

FIG. 3 is a side view of the rear of the bicycle frame for attaching chips;

FIGS. 4A-4D are views view of a first chip set used in the disclosed method;

FIG. 5A and FIG. 5B are views of a second chip set used in the disclosed method; and

FIGS. 6A and 6B are views of a third chip set used in the disclosed method.

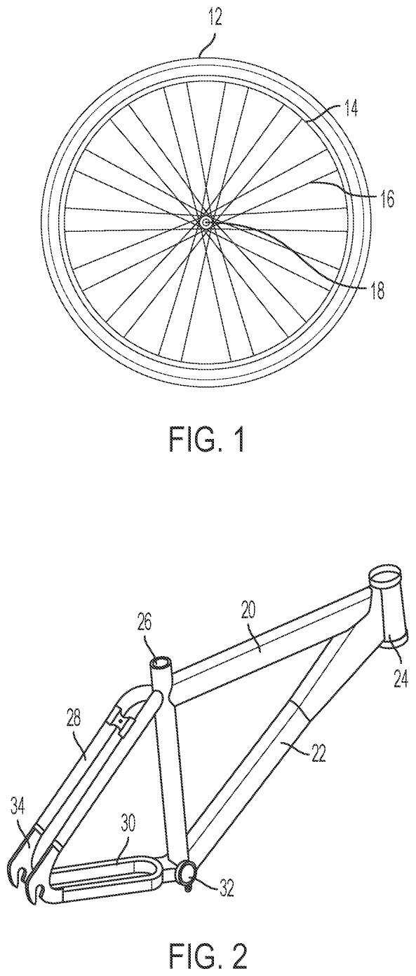

### DETAILED DESCRIPTION OF THE INVENTION

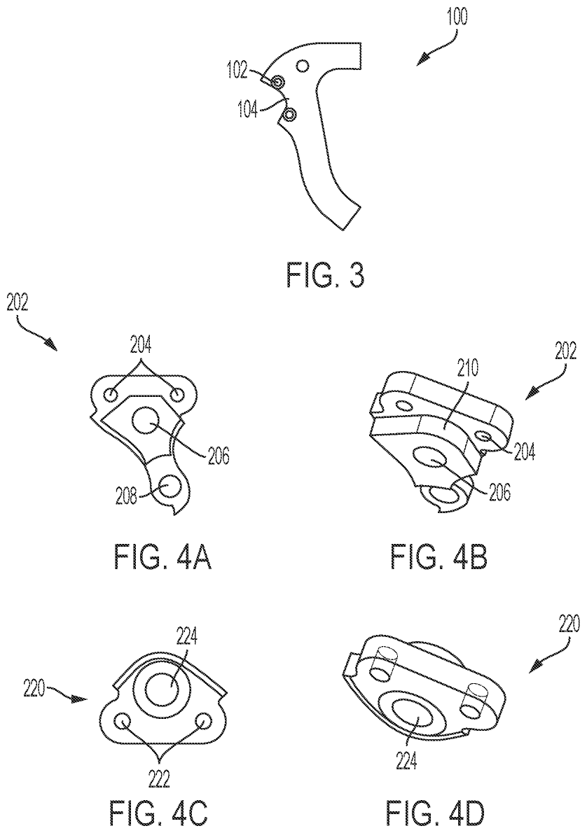

Different sized hubs can be attached to a bicycle frame by using a chip which attaches to the frame and hub. The chips are sized and shaped to accommodate a particular wheel hub. A pair of chips are preferable used, one chip of each pair on each side of the hub and frame. FIG. 3 depicts the rear end 100 of a frame for attachment of the chips. Each side of the bicycle frame has a pair of apertures 102 and a curved surface 104 for attachment of a chip. As the chips can first be attached to a wheel hub and then attached to the frame, a pair of apertures 102 instead of a slot can be used. Any suitable fastener, such as a threaded bolt, can be inserted through the apertures in the frame and the chips and secured. The use of apertures precludes rotation of the chip relative to the frame and the possibility of the axle slipping from the slot as used in the frame of FIG. 2.

The chips connected to the frame and wheel hub each have a two tiered structure, as will be explain in more detail below. The first tier has a pair of apertures that align with the pair of apertures 102 on the frame, allowing fasteners to pass through the aligned apertures to secure the chip to the frame. The second tier has an arcuate edge that corresponds to the curved surface 104 of the frame. The arcuate edge of the chip bears against the curved surface 104 of the frame.

FIGS. 4A-4D depict a first chip set used for a wheel hub of a first size. FIG. 4A and 4B are a side view and front perspective view, respectively, of a first chip 202 in the chip set. The first chip attaches to a first rear end of the bicycle frame. The second tier overlaps a middle portion of the first tier. As seen in FIG. 4A, two apertures 204 are in the first tier on a section extending from one side of the second tier and overlap the frame. The chip 202 has a central aperture 206 for attachment of an axle of a wheel. The first tier also has a portion extending from the second tier on a side opposite the pair of apertures 204. This extension has an aperture 208 intended for the attachment of a derailleur. Therefore, this chip is suitable for attachment of a wheel for a multispeed bicycle. The perspective view of FIG. 4B more clearly depicts the curved surface 210 that bears against the curved surface 104 of the frame.

The second chip 220 of the first chip set is depicted in FIGS. 4C and 4D. The second chip attached to a second rear end of the frame. The second chip 220 has a pair of apertures 222 for attachment to the frame and a central aperture 224 for attachment of a wheel axle. The second tier has a curved surface bearing against the curved surface 104 of the frame when the pair of apertures 222 are aligned with the pair of apertures 102 of the frame.

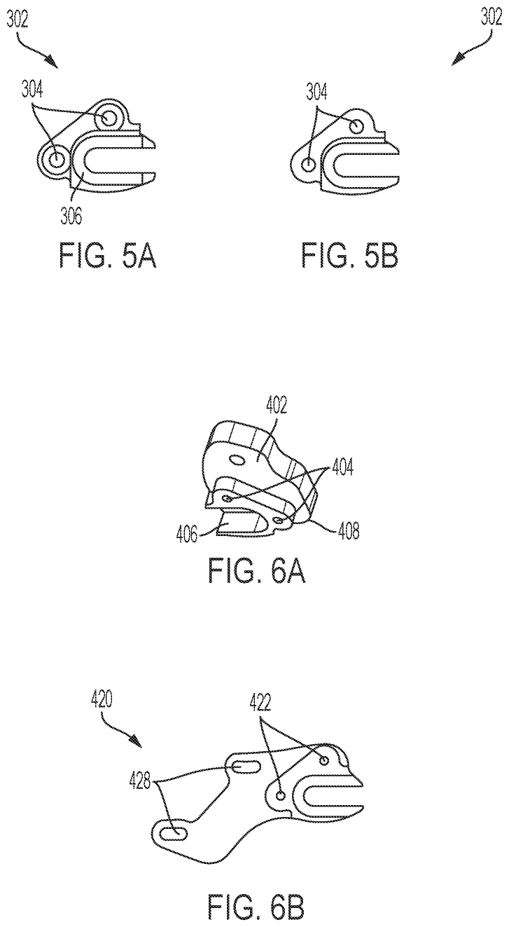

A second chip set 302 is depicted in FIGS. 5A and 5B. The chip 302 has a pair of apertures 304 that align with the apertures 102 of the frame and a curved surface 306 on the second tier to bear against the curved surface 104 of the frame. In addition, a slot 306 allows for the attachment of a wheel axle. The chip does not have any additional apertures for the attachment of other elements. Therefore, this chip set is suitable for a single speed bicycle of an internally geared wheel. The two chips in the chip set are mirror images of one another, allowing the chips to be attached to each side of the bicycle frame with the second tier aligned with the curved surface, while the first tier contacts an inner surface of the frame.

A third chip set is depicted in FIGS. 6A and 6B. The first chip 402 of the third chip set is seen in FIG. 6A. The first chip 402 has a pair of apertures 404 for attachment to the frame and a slot 406 for attachment of a wheel axle. In addition, a curved surface 408 is formed in the second tier. The second chip 420 has a pair of apertures 422 and a slot 424, as seen in FIG. 6B. In addition, an extension of the first tier has apertures 428 for attachment of a brake to be attached to a brake rotor on the wheel.

As seen in the figures, the chips of the chip sets have common features, such as a two tier structure and a curved surface corresponding to the curved surface 104 of the frame as well as a pair of apertures aligning with the apertures 102 of the frame. However, each of the chip sets has different features suitable for the particular wheel to be attached. For that reason, each chip in a chip set has a different profile than chips in another set. The profile refers to the shape of the chip as seen in a side view. In addition, the thickness of the chips is suited for the wheel to be attached. As seen in FIG. 6B, the thickness of chip 402 is greater than the thickness of the chips in the first chip set or the second chip set.

A kit may be used to practice the method which enables the user to attach different wheels to a frame. The kit would include the various chip sets, thereby providing the user the elements needed to selectively attach a variety of wheels to a frame. The chip sets, coupled with the knowledge of which chip sets to use with which wheels provides the flexibility to use a wheel suitable for the use of the bicycle, including factors such as terrain and the number of speeds for the bicycle.

The invention thus being described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of attaching wheels to a frame, comprising:
attaching a first chip set to a rear end of bicycle frame, the first chip set having a first chip and a second chip;
attaching a first wheel to the first chip set;
removing the first wheel and first chip set from the rear end of the bicycle frame;
attaching a second chip set to a rear end of bicycle frame, the first chip set having a first chip and a second chip, the first chip and second chip of the second chip set having a different profile than the first chip and the second chip of the first chip set; and
attaching a second wheel to the second chip set.

2. The method of claim 1, further comprising:
removing the second wheel and second chip set from the rear end of the bicycle frame;
attaching a third chip set to a rear end of bicycle frame, the third chip set having a first chip and a second chip, the first chip and second chip of the third chip set having a different profile than the first chip and the second chip of the first chip set and the first chip and the second chip of the second chip set; and
attaching a third wheel to the third chip set. 3, The method of claim 1, wherein the first wheel has a sprocket and the second wheel has a brake rotor, and
wherein the method further comprises:
attaching a derailleur to the first chip; and
attaching a brake for the brake rotor to the second chip.

4. The method of claim 1, wherein attaching the first chip set to the rear end of bicycle frame comprises aligning a pair of apertures on each of the first chip and the second chip with apertures on the bicycle frame and securing the first chip set to the rear end of bicycle frame with fasteners.
